(19) United States
(12) Patent Application Publication
(10) Pub. No.: US 2015/0046233 A1
(43) Pub. Date: Feb. 12, 2015

(54) METHODS AND SYSTEMS FOR PROVIDING THE EFFECTIVENESS OF AN ENTITY

(71) Applicant: THRIVE METRICS, INC., Hicksville, NY (US)

(72) Inventors: Natasha Srulowitz, West Hempstead, NY (US); Steven Skiena, Setauket, NY (US); Mark Fasciano, Port Washington, NY (US); Supriya Garg, Woodside, NY (US)

(21) Appl. No.: 13/960,094

(22) Filed: Aug. 6, 2013

(51) Int. Cl. G06Q 10/06

(52) U.S. Cl. CPC G06Q 10/06398
USPC 705/7.42

(57) ABSTRACT

A computer implemented method and system for providing to a user (a manager) the effectiveness of an entity (employee or group of employees) by analyzing emails, social network data, CRM, calendar data, audio/video data, typing speed, galvanic skin response, etc. The computer method captures, analyzes and displays communication volumes, response times, and sentiment metrics, enabling the user to understand the effectiveness of an entity, optimal use of resources, trends, customer contact, collaboration patterns, security issues, entity turnover, entity health, and ideal work environments.

### TECHNICAL FIELD

The present invention relates to a computer implemented method and a computer system for providing the effectiveness of an entity, and in particular to a computer implemented method and a computer system that analyzes employee electronic communications and physical actions to provide the effectiveness of an employee, a group of employees, and/or an entire organization.

### BACKGROUND OF THE INVENTION

For years, companies have sought to analyze workforce processes to help the management of the company make better decisions and use resources more effectively. Frequently employees and customers are asked to fill out surveys to determine the impact of certain initiatives taken by the company or topics affecting the company. However, filling out surveys is time consuming and may not disclose needed information because the questions can be limiting. Therefore, it is desirable to more powerfully assess the effectiveness of an employee, a group of employees, and/or an entire organization in order to help companies make better decisions and use resources more effectively. It is also desirable to identify and analyze in real time factors affecting optimal entity efficiency and engagement.

### SUMMARY OF THE INVENTION

The present invention is a computer implemented method and system for providing the effectiveness of an entity. The method and system allows management of a company to determine effectiveness of its corporate workforce in the context of day-to-day operations. It also allows the management to monitor customer relationships and all internal and external relationships that may affect the company's profits. The system and method analyzes data from a number of inputs to capture widely varying employee work styles and communication styles into specific metrics. The metrics allows the management to extract, for example: key traits of effective employees, optimal use of resources, trends within the company, customer contact, collaboration patterns, security issues, employee turnover, employee health, and ideal work environments.

The computer system includes an input for inputting a selected entity and an initial time interval, a network connection for receiving a plurality of communications data, a database for storing data and a processing unit programmed to perform the methods of the present invention. The method includes the computer receiving a plurality of communications data from a network; determining for each of the plurality of communications data, a participant, a time stamp and interaction data; receiving from a user a selected entity and an initial time interval; and firstly identifying which of the plurality of the communications data has its participant associated with the selected entity and its time stamp within the initial time interval.

Once the communications data is identified (or tagged), the computer determines a communications volume, which is associated with the quantity of the firstly identified communications data; determines the sentiment associated with the interaction data of the firstly identified communications data; and determines a response index from the interaction data of the firstly identified communications data. Finally, the computer provides the effectiveness for the selected entity by aggregating the communications volume, sentiment, and response index, and the computer then displays to the user the initial effectiveness of the entity. The communications data may be electronic communications data, such as, emails, blogs, social network data, calendar data, CRM data, etc. Alternatively, or additionally, the communications data may be physical interaction data of the participant, such as, galvanic skill response data, eye tracking data, brainwave data, gesture data, etc.

In one embodiment, the computer receives from the user, a minimum effectiveness level, and the computer generates an alert to the user when the initial effectiveness falls below the minimum effectiveness level.

The communications volume may include a send volume, a receive volume or a combination of both send volume and receive volumes. In another embodiment, the computer identifies at least one association between the firstly identified communications data; and the computer determines a location adjustment based on the at least one identified association. The location adjustment may be based on a known seating arrangement of employees.

In different embodiments, the selected entity may represent a single participant, i.e. an employee, or multiple participants, i.e. a group of employees. Each of the participants may be associated with the selected entity by an input. The input may be entered by an administrator (or the user) or it may be automatically entered from a directory database stored in the computer system 10 database 12 or accessed through the network. The receiver may be similarly associated with the selected entity.

In one embodiment, the response index is based on the difference between the time stamp of the firstly identified communications data and corresponding interaction times contained in the interaction data of the firstly identified communications data. Alternatively or additionally, the response index may be based on the difference between the send volume and the receive volume.

In another embodiment, the sentiment is determined for at least one identified topic. The at least one identified topic may be identified by the user or by an administrator of the computer. In another embodiment, the computer determines for each of the plurality of communications data, a subject/topic and deletes communications data having its subject/topic associated with a sensitive subject/topic. The computer may also identify and delete sensitive interaction data.

In another embodiment, the computer determines for the firstly identified communications data a content length associated with the interaction data, and aggregates the content length with the communications volume, sentiment, and response index to provide the effectiveness of the selected entity.

In other embodiments, the computer receives from the user a different time interval; secondly identifies which of the plurality of the communications data has its participant associated with the selected entity and its time stamp within the different time interval; determines a second effectiveness using the secondly identified communications data, determines a productivity measure based on a difference between the initial effectiveness and the second effectiveness, and then displays to the user the productivity measure. The productivity measure may be a health indication of the entity, an indication of an adoption of an initiative, an indication for an environment adjustment, or an indication of a performance projection.

In another embodiment, the computer receives from the user a different entity; identifies which of the plurality of the communications data has its participant associated with the different entity and its time stamp within the time interval; determines a second effectiveness using the secondly identified communications data; determines a comparison measure based on the difference between the initial effectiveness and the second effectiveness; and then displays to the user the comparison measure.

### BRIEF DESCRIPTION OF THE DRAWINGS

The aforementioned and other aspects, features and advantages can be more readily understood from the following detailed description with reference to the accompanying drawings wherein:

FIG. 1 is a block diagram illustrating the preferred embodiment of the present invention.

FIG. 2 is a flow diagram illustrating the preferred embodiment of the present invention.

FIG. 3 is a data flow diagram illustrating the preferred embodiments of the present invention.

FIG. 4 is a data flow diagram illustrating another embodiment of the present invention.

FIG. 5 is a flow diagram of a routine for associating entities with participants.

FIG. 6 illustrates an example of a screenshot displaying graphical data to a user in accordance with the invention.

FIG. 7 illustrates an example of a screenshot displaying numerical data to a user in accordance with the invention.

FIG. 8 illustrates an example of a screenshot displaying graphical data to a user in accordance with the invention.

FIG. 9 illustrates an example of a screenshot displaying graphical data to a user in accordance with the invention.

FIG. 10 illustrates an example of a screenshot displaying graphical data to a user in accordance with the invention.

FIG. 11 illustrates an example of a screenshot displaying graphical data to a user in accordance with the invention.

### DETAILED DESCRIPTION

Before the present invention is described, it is to be understood that this disclosure is not limited to the particular embodiments described, as these may vary. It is also to be understood that the terminology used in the description is for purposes of describing the particular versions or embodiments only, and is not intended to limit the scope. It is to be understood that each specific element includes all technical equivalents that operate in a similar manner. In addition, a detailed description of known functions and configurations will be omitted when it may obscure the subject matter of the present invention.

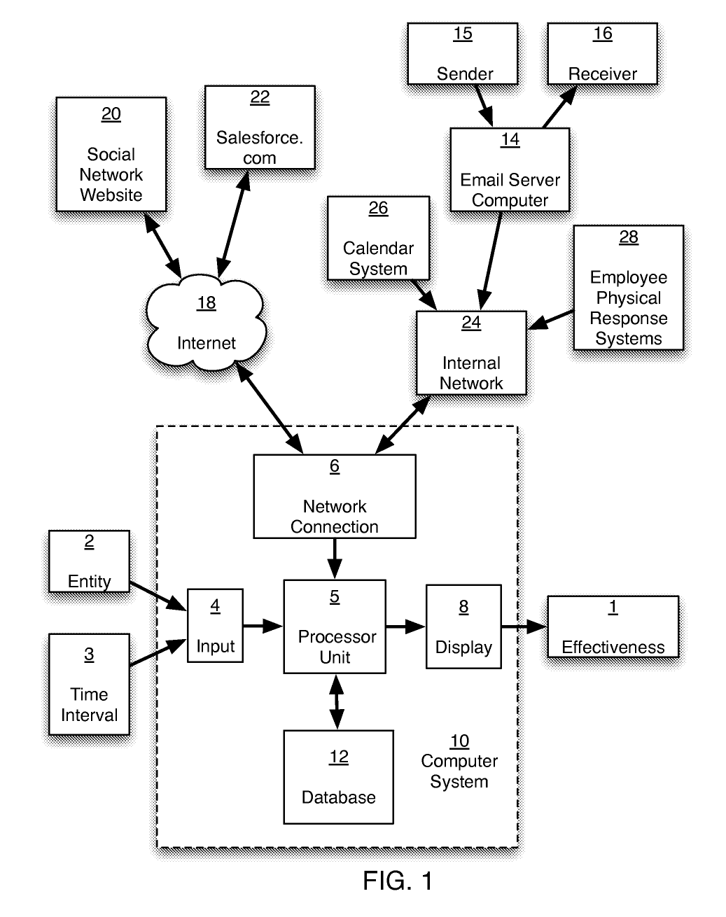

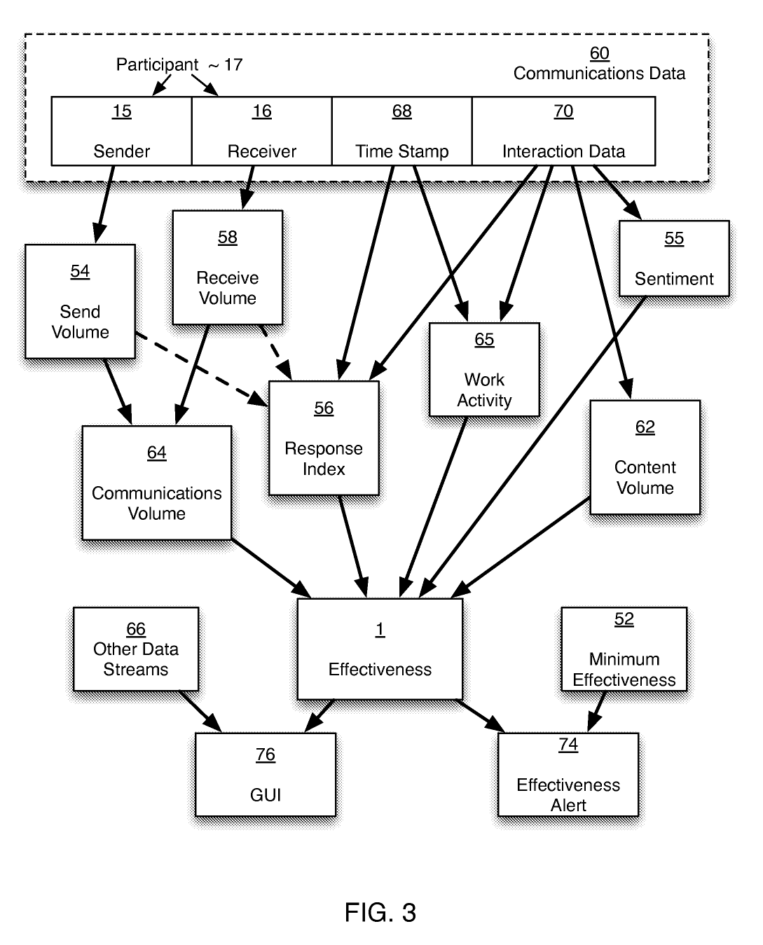

Referring now to the drawings, wherein like reference numerals designate identical or corresponding parts throughout the several views. Referring to FIG. 1, shown is an exemplary computer system 10 for providing the effectiveness 1 of an entity 2 during a time interval 3. The term “entity” 2 refers to a single individual or a group of individuals, such as, an employee, a group of employees performing certain functions, a department, a team, a committee, an entire company, or students. The term “time interval” 3 refers to the time between a selected start time and a selected end time, which may comprise any extent of time, such as a minute, an hour, a day, a week, a month, a year, multiple years, etc. The computer system 10 includes an input 4 for inputting a selected entity 2 and an initial time interval 3, a network connection 6 for receiving a plurality of communications data 60 (shown in FIG. 3), a database 12 for storing data, a processing unit 5 programmed to perform the methods of the present invention, and a display 8 for displaying to a user the effectiveness 1 of the entity 2, which may be displayed in a number of forms as described below. The selected entity 2 and the initial time interval 3 received from the input 4 may be typed in by a user (or scanning, spoken, etc.) or may be selected by a user based on a list displayed to the user by the display 8. Additionally, the computer system 10 may connect to the internal network 24 of the company for selected entity 2 and the initial time interval 3 input by designated users over a secure shell user interface.

The network connection 6 may receive communications data 60 from the company's internal network 24 or from external systems over the Internet 18. The internal network 24 may receive the plurality of communications data 60 from, for example electronic communications data 60 such as email from an email server computer 14 or appointments from a calendar system 26. Other electronic communications data 60 may include phone logs, voice mail, CRM, audio (including ambient sound), video, document changes and other work activities. The internal network 24 may also receive physical communications data 60 from employee physical response systems 28. Employee physical response systems 28 may include measured brain waves, typing speed, mouse activity, galvanic response, gesture recognition (e.g. kinetic technology), eye tracking, and Google glasses inputs. The network connection 6 may also receive communications data 60 from external systems over the Internet 18, such as, data from salesforce.com 22 or social network websites 20 (Facebook, twitter, LinkedIn, blog entries, etc).

The computer system 10 is programmed to analyze a plurality of communications data 60 to provide the effectiveness of an entity 2. The plurality of communications data 60 may come from a single source or from a combination of sources, which may include systems connected to the internal network 24 and/or the Internet 18. The selection of the type of communications data 60 used for providing the effectiveness 1 of an entity 2 may be programmed into the computer system 10 by an installer or by a system administrator, as known by one skilled in the art. Alternatively, the selection of the type of communications data 60 used for providing the effectiveness 1 of an entity may be selected or changed from a prior setting by a manager (a user) trying to assess employee effectiveness 1 or identify factors affecting employee effectiveness 1. In this embodiment, the user selects the source of communications data by inputting his selection into the input 4 (similar to entity 2 selection and time interval 3 selection).

An example of the invention showing the analysis of employee emails will be described. Once the computer system 10 is connected to a company's internal network 4, a system administrator initiates the collection of employee emails from the company email server computer 14, which may be accomplished using input 4 and display 8. As employees (participants) 17, send emails to receivers 16, the email server computer 14 saves information related to the emails. For example, the computer system 10 may extract or spider email from email servers (such as Exchange and Gmail), email journaling/archiving servers, social network systems like Jive, etc. The computer system 10 can either push or pull the communications data 60. In a pull-based approach, the computer system 10 will actively and regularly query the email server to retrieve the latest information. For an email server like Microsoft Exchange, this means accessing mailboxes via Exchange Web Services or other email server technologies via the IMAP protocol. In a push-based approach, like journaling, the email server will be programmed to send information to a central place as it arrives. This push-based approach eliminates the need for authorization credentials and minimizes the computational load on the email server. Similar approaches work with social networking platforms and other communications media.

When the computer system 10 receives the email information (communications data 60) into the network connection 6, the processor unit 5 stores it in database 12. Subsequently, when a manager (user) enters an entity 2 and a time interval 3 into the input 4, the processor unit 5 begins to provide the effectiveness 1 of the entity 2. If the entity 2 is a group of employees, such as a department or a job function, the processor unit 5 will access a company directory database to associate certain employees with the entity 2. The company directory database contains information about the employee such as the employee's name, email address, phone number, department, job function, salary, desk location, and performance rating. The company directory may be stored in database 12 or may be accessed from the internal network 24 or Internet 18. To associate certain employees with the entity 2, for example department, the processor unit 5 compiles a list of employee email addresses that employees in the selected department would use. The processor unit 5 then tags (or retrieves) all the stored email information sent having an email contained in the compiled list of email addresses and that was sent during the time interval 3. The processor unit 5 then analyzes the tagged email information to provide the effectiveness 1 of the entity 2, as described below. The processor unit 5 formats the determined effectiveness 1 of the entity 2 for the display 8 to the manager, as described below.

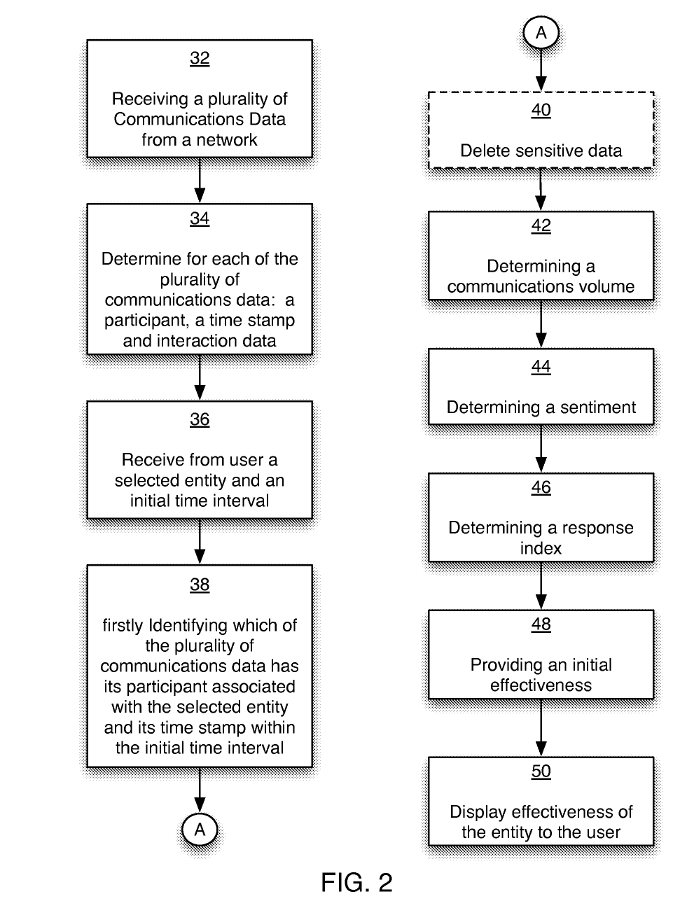

Referring to FIG. 2 and FIG. 3, the flow diagram of a routine that enables the determination of the effectiveness 1 of the entity 2 is shown in FIG. 2 and the flow of information for providing the effectiveness 1 of the entity 2 is shown in FIG. 3. The method includes the computer system 10 receiving a plurality of communications data 60 from a network (step 32) and determining for each of the plurality of communications data 60, a participant 17, a time stamp 68 and interaction data 70 (step 34). The participant 17 may be a sender 15 (initiation information), a receiver 16 (destination information), or both sender 15 and receiver 16. In the communications data 60, the participant 17 is represented as an identifier of the individual that has originated or received the information contained in the communications data 60. A sender 15 is an identity of an originator of an email, the originator of brainwave information, the originator of calendar information, etc. A receiver 16 is an individual who receivers emails and email copies, such as CC and BCC; text messages; document; etc. A time stamp 68 is the time that the information was originated by the sender 15, and interaction data 70 contains the information that was originated by the sender 15. This information may include the contents of an email message and more as further described below.

The computer system 10 then receives from a user a selected entity 2 and an initial time interval 3 (step 36). The entity 2 may include more that one individual. The computer system 10 determines identifiers (participants 17) that are associated with the entity 2 by accessing a database 12 that stores the associations of the individual(s) with identifiers. The database 12 may also contain associations of individuals with groups so that when the user selects a group containing more than one individual, all identifiers are used. The creation of this database 12 is described below. The term “initial” is used in this step to distinguish this time interval 3 from a “second” time interval that the user enters for another embodiment in which two different effectivenesses 1 are compared to determine a change in productivity of the entity 2. However, the use of the term “initial” does not imply that there has to be another time interval 3 entered by a user. Also the “initial” time interval 3 may be an earlier or a later time interval from the “second” time interval 3.

Next the computer system 10 firstly identifies which of the plurality of the communications data 60 has its participant 17 associated with the selected entity 2 and its time stamp 68 within the initial time interval 3 (step 38). The term firstly is used to distinguish from secondly identified communications data 60 that may be collected during the second time interval or from a different entity in other embodiments. Participants 17 are associated with entities 2 in a number of ways as described below.

In one embodiment, the computer system 10 deletes sensitive data from the firstly identified communications data (step 40). This step is dashed because it is not necessary for all embodiments. Sensitive data may include employee information or other subjects/topics discussed below.

The computer system 10 next determines a send volume 54, which represents the quantity of communications data 60 (or particular types of communications data 60) that was originated by the participants 17 associated with the entity 2 (step 42). The computer system 10 also determines a sentiment 55 associated with information in the interaction data (step 44). The computer system 10 determines the sentiment 55 first by performing natural language processing (in some embodiment specifically for an entity, a subject/topic and/or specific sentiment terms) to identify text strings of interest in each communications data 60 and then by performing sentiment analysis. In the preferred embodiment, sentiment analysis uses grammatical techniques and a sentiment lexicon of positive and negative words to ascribe sentiment to subjects and communications of the participant 17.

The computer system 10 also determines a response index 56 (step 46). The response index 56 may represent a measure of the participant's 17 response to certain activities. In one embodiment, the response index 56 is based on the difference between the time stamp 68 of the firstly identified communications data 60 and corresponding interaction times contained in the interaction data 70 of the firstly identified communications data 60. Alternatively or additionally, the response index 56 may be based on a balance of the send volume and the receive volume 58; and/or a percent of emails responded to. This will be further described below.

The computer system 10 next provides an initial effectiveness for the entity by aggregating metrics which may include communications volume 64, sentiment 55, response index 56, work activity 65 and/or the content volume 62 (step 48). The content volume 62 may represent the complexity or the “size” of the communications data 60 reflecting the amount of information conveyed in each message, typically a function of the intensity of the activity and its duration. For text modalities, content volume 62 naturally reflects in the number of characters in each message; for more analog modalities it reflects the compressed size of each recorded data stream. In some embodiments, the computer system 10 may aggregate into the effectiveness 1, the work activity 65. Work activity 65 may be a measure of the length of an average workday based on the times when an employee was actively engaged as further described below.

In one embodiment, the computer system 10 may “aggregate” by arithmetically combining metric, i.e. the communications volume 64, response index 56, sentiment 55, work activity 65, and/or the content volume 62, as further described below. In this embodiment, the computer system 10 provides the effectiveness 1 of the entity 2 to a user by displaying the arithmetically combined metrics, possibly in graphic form over time. In a different embodiment, the computer system 10 may “aggregate” the metrics by providing correlated graphs displaying to a user each of the metrics separately over the same time interval.

Lastly, the computer system 10 displays to the user the effectiveness 1 of the entity 2 (step 50). In one embodiment the graphical user interface (GUI) 76 shows the effectiveness 1 in conjunction with other data streams 66 (FIG. 3). The GUI 76 allows the user to view the communications volume 64, response index 56, sentiment 55, content volume 62, and other data streams 66 relative to each other over the time interval 3. Other data streams 66 may include: resources available during the time interval 3 (i.e. money spent by the company), total sales that occurred during the time interval 3, world events that occurred during the time interval 3, and/or company events that occurred during the time interval 3. The other data streams 66 may be received by the computer system 10 from the user or may be downloaded from the company internal network 24 or the Internet 18. Examples of different user displays will be further described below.

In one embodiment, the user may input a minimum effectiveness 52 into the computer system 10 and if the effectiveness 1 is below the minimum effectiveness 52, the display 8 produces an effectiveness alert 74. This feature may be useful when the effectiveness (or the sentiment 55 or response index 56) is continuously determined, allowing the effectiveness alert 74 to signal to a user that there is an issue. The effectiveness alert 74 may be a sound, an icon flashing on a computer screen, an email, a text, etc.

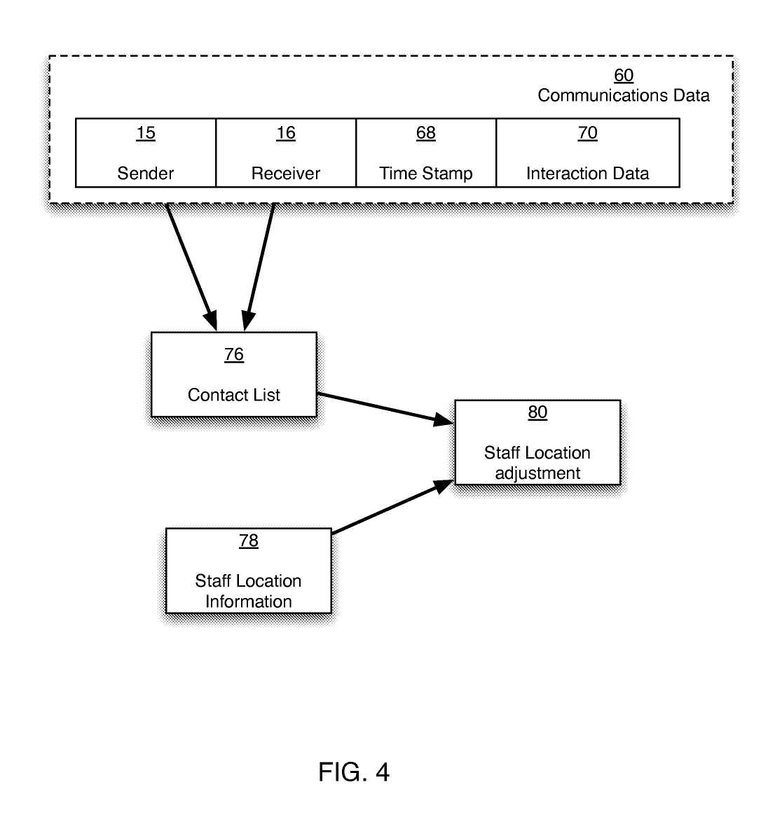

Referring to FIG. 4, in another embodiment, the computer system 10 may determine from the communications data 60, associations between employees to determine a contact list 76. The contact list 76 may be a collection of all employees having contact with each other, all employees having contact with outside contacts, and/or all employees having contact with customers, etc. The contact list 76 will be helpful to a company when an employee leaves the company.

In another embodiment, the computer system 10, after identifying associations between employees from the communications data 60, determines a staff location adjustment 80 to increase employee efficiency 1. The staff location adjustment 80 is based on prior staff location information 78 i.e. the physical arrangement of the office environment. The association between employees may be determine by identifying a minimum number of communications data 60 where two employees are the sender 15 or the receiver 16 of a communications data 60. The staff location adjustment 80 may be determined by determining how often employees having contact with each other (or contact with outside contacts and/or contact with customers) and if their location relative to frequent contacts can be optimized for improved efficiency 1. People who communicate frequently should be located near each other. The computer system 10 measures the number and pattern of communications between groups and co-workers, enabling informed decisions to be made as to optimal location of the employees.

Lastly, in step 50 (FIG. 2), the computer system 10 displays to the user the effectiveness 1 of the entity 2. Examples of different displays will be further described below. In one embodiment, the user may input a minimum effectiveness 52 into the computer system 10 and if the effectiveness 1 is below the minimum effectiveness 52, the display 8 produces an effectiveness alert 74. This feature may be useful when the effectiveness (or the sentiment 55 or response index 56) is continuously determined allowing the effectiveness alert 74 to signal to a user that there is an issue. The effectiveness alert 74 may be a sound, an icon flashing on a computer screen, or the like.

As described above, each stream of communications data 60 provided to the computer system 10 has an associated participant 17, timestamp 68, and interaction data 70. The interaction data 70 may include the content of a message (as a text document or character stream, perhaps created after speech-to-text analysis of voice communications), additional timestamps (i.e. for emails, when was it read, forwarded, archived, or deleted), or physical interaction data such as the galvanic response of a participant 17. The communications data 60 may also contain a subject/topic (not shown in the figures).

In the preferred embodiment, communications data 60 streams can be treated in a consistent way even if they are superficially different. The first step in the processing of any communications data 60 is reducing it to a minimal representation for further processing. For emails, as one example, this typically means identifying the participants 17 (senders 15, an receivers 16), time of creation (time stamp 68), communications type (origin, reply, calendar entry, etc.), subject, and sentiment words (interaction data 70). For calendar data, as another example, each update has a person calling the event (sender 15), a time when it is being made (time stamp 68), a set of people involved in the meeting (optional), and a textual description associated with it (interaction data 70). Further, other communications streams (blogs, CRM systems, voice mail after digitization), call logs, etc. all have the same basic properties, and can thus be analyzed with the same infrastructure.

This infrastructure allows retrieval of metrics (i.e. communications volume 64, response index 56, sentiment 55, content volume 62 and work activity 65) from, for example, corporate emails of multiple small-scale businesses on typically an hourly basis, although it may happen on both faster and slower time cycles, and in the limiting case, reaching real time. Based on these metrics, the computer system 10 is able to identify efficiency 1 of a user selected entity 2, spatial and temporal trends affecting efficiency 1 (or productivity), and relationships for the various employees and teams in a company.

Related work includes research on “email rhythms” to provide insights about patterns of communication include: Mandic, M. and Kerne, A. Using intimacy, chronology and zooming to visualize rhythms in email experience. CHI'05 extended abstracts on Human factors in computing systems, (2005), 1617-1620; Perer, A., Shneiderman, B., and Oard, D. W. Using rhythms of relationships to understand e-mail archives. Journal of the American Society for Information Science and Technology 57, 14 (2006), 1936-1948; Tyler, J. R. and Tang, J. C. When can I expect an email response? A study of rhythms in email usage. Proceedings of the eighth conference on European Conference on Computer Supported Cooperative Work, (2003), 239-258; U.S. Department of Commerce Census Bureau. Statistics about Business Size including Small Business. 2007, incorporated by reference herein. Related work also includes research on SocialFlows, MacLean, D., Hangal, S., Teh, S. K., Lam, M. S., and Heer, J. Groups Without Tears: Mining Social Topologies from Email. Intelligent User Interfaces, ACM (2011); GroupGenie, Purtell, T. J., MacLean, D., Teh, S. K., Hangal, S., Lam, M. S., and Heer, J. An Algorithm and Analysis of Social Topologies from Email and Photo Tags. (2011); and ContactMap, Whittaker, S., Jones, Q., Nardi, B., et al. ContactMap: Organizing communication in a social desktop. ACM Transactions on Computer-Human Interaction (TOCHI) 11, 4 (2004), 445-471; which help organize social contacts and which are incorporated by reference herein.

Currently, there exist streams of data capturing of all facets of an individual's personal and professional life in multimedia form including text, audio and video. The process of recording and archiving all such information in an individual's life is called lifelogging. The research project MyLifeBits (see Gemmell, J., Bell, G., and Lueder, R. MyLifeBits: a personal database for everything. Commun. ACM 49, 1 (2006), 88-95, which is incorporated by reference herein) at Microsoft uses SQL to support lifelogging by storing all personal information found on computers to support: hyperlinks, annotations, reports, saved queries, pivoting, clustering, and fast search. Research by O'Hara et. al. (see O'Hara, K., Tuffield, M. M., and Shadbolt, N. Lifelogging: Privacy and empowerment with memories for life. Identity in the Information Society 1, (2009), 155-172, which is incorporated by reference herein) looked at the technological possibilities and constraints for lifelogging tools, and argued that in a more socially-networked online world, most of the information gathered will have public functions and will be voluntarily released into the public domain. The shift from private conversations on email, chat and phone to social platforms like Facebook, Twitter, along with the rise of content sharing sites like Flickr, Youtube, and reddit illustrates the move to social media for personal communication. Similarly, the communication within companies, though still focused largely on private conversations are a treasure trove of information that can be indexed and analyzed to improve both the performance and morale of the company.

In addition, other communications streams producing communications data 60 include but are not limited to brainwave sensing (e.g. EEG), video, audio (including ambient sounds in the background such as typing and mechanical feedback), gesture recognition (e.g. Kinect technology), attention monitoring via eyetracking, measurements of galvanic skin response, typing speed/mouse activity, the frequency of document changes and other work activities, and signals from wearable computing devices (e.g. Google glasses). These modalities can be modeled using the same message communication paradigm as email or social media: the sender 15 of the communications data 60 is the person originating the communication, i.e. the creator of the brainwaves, the actions observed in the video, the creator of the sounds, gestures, or eye motions, perspiration, keystrokes, finger activity, head movements, and textual updates, respectively.

One consequence of this structure is that the computer system 10 can readily integrate communication streams from two different media into a single stream for analysis, or two parallel streams whose performance can be compared on the exact same set of scales. This might identify employees who are actively calling and participating in meetings as efficient and engaged even if they communicate infrequently by or respond slowly to electronic mail.

Based on an input from a user (for example the selected entity 2), the computer system 10 can be configured in either an individual mode (entity 2 is associated with a single participant 17) or a group mode (entity 2 is associated with multiple participants 17). In individual mode, aggregate metrics for individual are calculated. In group mode, group-level aggregate metrics are calculated. In this mode, individual metrics are aggregated into group-level statistics, after which the raw, per-message data may be discarded. An objective of using a group mode may include isolating optimal behavior associated with groups of top performing employees to compare them with existing company metrics, and measuring communication patterns between front-line workforce and customers in order to maximize customer experience and continuity while optimizing the resources spent on retaining them.

In both individual and group modes, the entity 2 is associated with participants 17. Participant(s) 17 may be associated with an entity 2 upon manual input from a user or automatically from a company directory. For manual association, the computer system 10 may receive the associations into input 4 (shown in FIG. 1), or the computer system 10 may connect to the internal network 24 of the company for input by designated users over a Secure Shell user interface. This is appropriate for small organizations, but is difficult to scale to a large corporate structure.

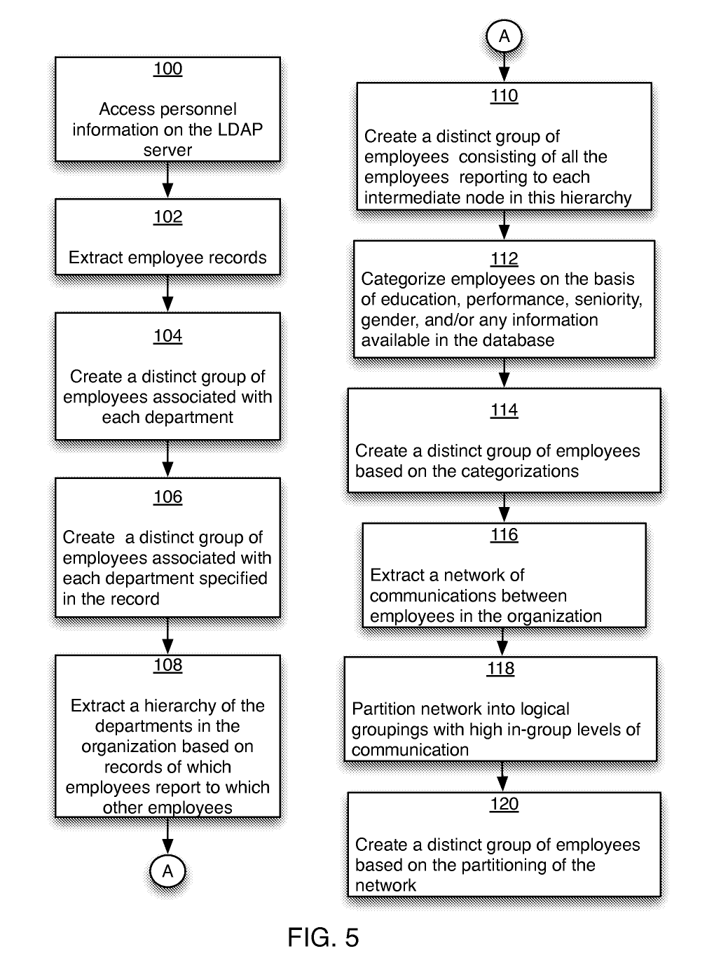

For automatic associations from a company directory, the computer system 10 integrates with directory services (LDAP based services like Active Directory) for purposes of mapping employees to their departments, managers, functional groups and so on. This information is updated on a regular basis, for example by polling the directory server daily. The structure of an organization can be determined from records stored in the database 12, text files reflecting job descriptions, or email system using the Lightweight Directory Access Protocol (LDAP) or other technologies such as Active Directory to define groups of related personnel. Typically information about a departments and locations are stored in the LDAP. Alternately, we can define groups by their communications patterns (e.g. all people from a set of companies emailing a particular department) or on the basis auxiliary data like job titles or email addresses. Referring to FIG. 5, shown is a flowchart of an exemplary process for automatically associating identifiers of employees (participants 17) to the entity 2. This process occurs periodically, for example once a day, once a month, etc. The computer system 10, accesses personnel information in a database on the LDAP server (step 100). The computer system 10 then extracts records corresponding to each employee (step 102). The computer system 10 creates and names a distinct group of employee associated with each physical location specified in the records (step 104). The computer system 10 also creates and names a distinct group of employees associated with each department specified in the record (step 106). The computer system 10 extracts a hierarchy of the departments in the organization, based on records of which people report to which other people (step 108). The computer system 10 also creates and names a distinct group of employees consisting of all the employees reporting to each intermediate node in this hierarchy (step 110). The computer system 10 also categorizes employees on the basis of education, performance, seniority, gender, and/or any information available in the database (step 112). The computer system 10 creates and names a distinct group of employees based on the categorizations above (step 114). The computer system 10 also extracts a network of communications between employees in the organization (step 116). The computer system 10 may use a clustering algorithm to partition this network into logical groupings with high in-group levels of communication (step 118). The computer system 10 then creates and names a distinct group of employees based on the partitioning of the network (step 120).

In other embodiments, a different mechanism for defining groups is based on performance or background. The computer system 10 can employ algorithms to group employees into tiers based on a stored database variable (or collection of such variables) providing stratification by education level, seniority, or gender, as representative examples. Alternately, the system can group into tiers based on measures extracted from computational analysis of the communication data 60 stream itself, like responsiveness (response index 56), sentiment 55 or effectiveness 1. In addition, a user can prioritize the most important groups, by manual selection and editing. A user can also create and edit the composition of groups manually. The ranking and selection of important groups can also be done algorithmically based on statistical variables such as size of group, communications volume 64, or centrality methods such as PageRank.

The computer system 10 may identify text strings of interest in each communications data 60 it receives by performing natural language processing (particularly participant 17 recognition and subject extraction), as known to one skilled in the art. The key extracted information is stored in a database 12 (the database can be on a cloud instance like Amazon Web Services). In addition, the natural language processing can be performed in multiple languages through translation or straightforward pattern matching of a whitelist of topics/subjects and sentiment words if a language-specific topics/subjects recognition/sentiment analysis system is not available for a particular language.

In one embodiment of the present invention, the user may select sentiment “lenses” that contain specific lexicons (sentiment terms) to use for aggregating the communications data 60. For example, identified communications data 60 would be analyzed specifically for certain sentiment terms. Similarly, the user may select certain topics or subjects (identified topics), and the identified communications data 60 would be analyzed specifically for the identified topics. In another embodiment, the computer system 10 may determine trending topics. There are two aspects to identifying trending topics: (1) isolating potential subjects of discussion, and (2) computing which of these are actually trending. For the first, we consider the complete set of proper nouns or other nouns we have extracted from the discussion over the given time interval, filtered by removing all topics mentioned infrequently, less often than a given threshold number of times. Selecting which topics are trending typically starts by identifying which topics have the greatest absolute number of references in the most recent time interval. Note, however, that many such topics are always popular, and it would be misleading to label the most frequent topic of discussion (typically the company name) as trending. It is desirable to measure the “unusualness” of mentions. A good way to do this is to use Z-scores, namely the number of mentions in a period divided by the standard deviation of the topic over similar-sized periods, and select the topics with the highest z-scores as trending.

The preferred embodiments of the present invention isolate certain metrics that are good predictors of engagement/effectiveness and combine them to get the effectiveness 1 of an entity 2. In one embodiment, this involves applying a machine learning process to the current and past data to learn the metrics. The system uses linear regression models in which the measurement is a linear combination of normalized metrics. The effectiveness 1 of an entity may be an aggregate of two, three, four or more underlying metrics, each scaled to the desired range. The metrics may include communications volume 64, response index 56, sentiment 55, work activity 65, content volume 62.

The communications volume 64 may be determined in a number of methods. The simplest measurement of communications volume 64 may be a count of the number of communications sent and/or received by each participant 17 over a particular period of time. More refined analysis takes into account the text or information contact of each message, how much of it is original content as opposed to forwarded replies of earlier communications, and the nature of the communications: original text emails may count as a greater communication than a mere forwarded link to a trending photo or article. Other analysis may include a discount of communications volume 64 for the same email sent to multiple people.

In the preferred embodiment, the method includes determining the sentiment 66 of the communications data 60. Sentiment analysis may be performed using grammatical techniques and a sentiment lexicon of positive and negative words to ascribe sentiment to subject/topics and the communications of participants 17, and the groups they are associated in. Sentiment analysis can be used to examine topic specific communication to identify relationships and discussion topics between various employee groups and with clients. This approach is useful in determining workforce priorities, customer interests or concerns, as well as adoption of and impact patterns from ongoing corporate changes.

In order to perform sentiment analysis on emails, for example, unique characteristics of e-mail need to be taken into account including: (1) document lengths are much shorter than that of blogs and articles, often just a sentence or two; (2) nicknames and colloquial terms are used frequently, making entity detection more difficult; (3) informal sentence structures make it harder to identify the subject/topic and the associated sentiment; and (4) the privacy of confidential communication must be preserved before and after sentiment analysis. The informal structure and short length of messages makes capturing the frequency and sentiment of discussions around company policies, current projects, customers, product types, strategic shifts and so on, a difficult task.

To perform sentiment analysis, the computer system 10 may use a sentiment score in the range [−1, +1] with the neutral sentiment at 0. A representative formula for computing a sentiment score is:

f(pos,neg)=((pos+neg)/(pos−neg)+1)*50
pos: Total score of positive sentiment phrases. (a positive number)
neg: Total score of negative sentiment phrases. (a negative number)

### Sample 1:

### Subject: RE: 2012 Review Feedback

Randy, I don't have a “Start, Stop or Continue Doing” for Donna but I do have a few things that I would like (+1) to mention.

Donna's been a tremendous help (+2) to me as she has spent a lot of time with me during my period of training. She's always there for me when I have a question. I can always count on her for her support (+1) and she knows she can always count on me. There were many times when I knew she was extremely busy but if I needed her help (+1) with something, she was always willing to help (+1) and never once complained (−1). On many occasions, she would stop what she was doing to lend a hand.

I feel very confident (+2) in my new role and it has a lot to do with the fact that Donna trained me. She is very dedicated (+2) to the team and I'm sure (+1) you feel lucky (+1) to have her on yours!

Sentiment score: f(12,−1)=92

### Sample 2:

### Subject: SO 266789

The above SO has me as sales responsible (+1) but since this is a House West, West order (+1) Ron should be assigned as sales responsible (+1). When you have time please (+1) have this fixed, thanks (+1)!

Sentiment score: f(5,0)=100

### Sample 3:

### Subject: RE: NEED STATUS—URGENT

It's amazing (+1) that I never got an answer from Denis yesterday. The feedback I provided yesterday was based on feedback I got talking to the techs because I got tired (−1) of waiting.

It is unacceptable (−1). Not even a response that says ‘I don't have an answer but will provide an update tomorrow’

Sorry (−1)—just venting.

Sentiment score: f(1,−3)=25

Apart from the concept of positivity and negativity of sentiment in communication data 60, companies are interested in knowing if their employee groups are using appropriate language while communicating with other groups and customers.
Politeness: Employees are expected to be polite in all communication with customers, and cordial while communicating internally. This includes the absence of aggressive and rude language.
Collaboration: In internal communication, a collaborative tone signals team spirit and a sense of belonging.
Optimism: Optimism in communication can signify both a can-do attitude of employees, and their confidence in the company/product.

Based on the interest in such information, one embodiment of the present invention uses custom dictionaries to track these special sentiments. This information is especially valuable in the case of customer interaction, and can give companies early warning to step in and train their employees when their language is widely off from the expected norms.

The “sentiment” of the communication data 60 stream will reflect a modality-specific analysis of the intensity of each message. For text modalities, the sentiment analysis techniques employed for email analysis are directly applicable; for more analog modalities like EEG and galvanic skin response the sentiment will be a function of the magnitude and frequency distribution of the underlying signals. For example, galvanic skin response measures the changes in conductivity of skin, which varies with moisture level typically associated with psychological or physiological arousal. Conductivity is a measured function which varies with time, so can naturally be partitioned into regions where conductivity can be observed to either be: “rapidly increasing”, “increasing”, “steady high”, “steady moderate”, “steady low”, “decreasing”, or “rapidly decreasing”. This stream of region descriptions can be interpreted as a text stream, where certain descriptions (like “rapidly increasing”) may be associated with negative sentiment. Similar interpretations can be made for any waveform, which can be measured and quantified.

In the preferred embodiment, responsiveness (response index 56) is a measurement that combines response time and percentage of response to signify how responsive employees are to their received communication. The response index 56 may be a score that lies in the range [0, 100]. A representative calculation of the response time might be the average time difference when the employee received an email from when he/she read or respond to it.

In an alternate embodiment, the response index 56 is based solely on the difference between the time stamps 68 of the firstly identified communications data 60 and corresponding previous time stamps contained in the interaction data 70 of the firstly identified communications data 60 (communications data 60 is a response to earlier email). Alternatively or additionally, the response index 56 may be based on the difference between the send volume 54 and the receive volume 58. Further, in the case of electronic mail, the response index 56 may be based on the percentage of communications data 60 that receive a response within a specified time, for example a week. For a modality such as EEG, the initial communications data 60 might be the time stamp of a sending party speaking in a room, and the response being time defined by when the receiving/listening party's EEG reacts to hearing this message. Responsiveness is a measure of how quickly a person replies to a communications. For a particular piece of communication, it computes the difference between the origin or receipt time for a communication and the time when it was read, archived, deleted, or responded to. Detailed interaction data on reading, archiving, and deleting is typically only available when employing a pull-based spidering technology. For push-based technologies, response times can be obtained by pairing up the time stamps of reply or forward messages with the original text.

In the preferred embodiment, the computer system 10 provides the effectiveness 1 of an entity (employee) by assigning a score, in a range of 0 to 100, based on communication volume 64, sentiment 55, and responsiveness (response index 56). For example, an employee with a high sentiment 55 and average communications volume 64 and response index 56 may be regarded as equivalently effective 1 or engaged to an employee with average sentiment 55 and response index 56 and high communications volume 64.

The effectiveness 1 of an entity 2 is meaningful when it is compared to a baseline. The baseline can be determined in two ways: (1) by an operator based on their experience and judgment of what makes for productive and effective employees, and/or (2) by machine learning based on annotated employee performance data. In the second case, we start from data labeling the productivity a given set of groups or employees, presented either in tiers or scored on a nominal scale. Machine learning techniques like regression, clustering, and support vector machines can be applied to the measurement data to try to predict these labels from variables extracted from communications data 60. This induced formula can serve as the effectiveness 1 for the entire organization.

The present invention captures two useful components—how well a person or team is performing in comparison to other persons or teams with the same role, and how this performance is changing over time. The change component can be very important since communication habits, including tone vary from team to team, and a drastic change in this behavior may be a good indicator of change in the team's effectiveness 1 at the workplace.

In the preferred embodiment, the metrics are first normalized using appropriate benchmark values. Benchmark values are in lieu of the expected values for each metric, and are calculated based on the average values in the peer group of the concerned team (or person). The baseline may also be adjusted for the activity level at the given time. To determine the baseline the computer system 10 computes statistics, such as the mean, variance, and standard deviation of the metrics over all groups (or individuals). In particular, the Z-score (computed as (X-mean)/std, where X is the observation, mean is the average, and std is the standard deviation of the variable.) provides a good basis for measuring how interesting/unusual a particular metric is.

The group and job role information from the company directory (provided by a user, stored in database 12 or accessed through the network connection 6) is also used to determine the appropriate benchmark group for each individual or team. The effectiveness 1 for an employee is a function of the degree to which the calculated metric is above or below the benchmark value. Given the per-indicator benchmark values, we can calculate both the normalized values, as well as the change values:
\hat{v}₁: Normalized indicator value, i.e. indicator value as a fraction of a benchmark value:
Δvᵢ: Rate of change in value over time (weekly/monthly):

$$Δ {v}_{i} = \frac{\partial \hat{{v}_{1}}}{\partial t}$$

These rates of change can be computed over any time scale, including the range from hourly to annually. Metric changes can also be calculated over clock/calendar cycles, such as time of day or month/season of the year. Given these normalized values, the measurement score of a metric is a weighted sum of the normalized and delta indicator values:

Measurement score=Σ_{i εindicators}(\hat{v}₁*θᵢ+Δvᵢ*φᵢ) where Σᵢ(|θᵢ|+|φᵢ|)=1

The values for the “who” indicators which assign a score to communication patterns are more complex to calculate since they are not simple numerical values. Essentially, for these indicators, the actual value as well as the benchmark value is a distribution of email traffic (for example) over different groups of relationships, and is best represented as a vector. For example, teams of developers might have the benchmark as 75% from team members, 10% from collaborator group, 5% from senior management, and 10% from everyone else. Since these are already normalized values, \hat{v}_{who} can be calculated as the weighted sum of differences from the benchmark values:

$${benchmark}_{who} = ( {b}_{{g}_{1}} , {b}_{{g}_{2}} , … ) , {v}_{who} = ( {v}_{{g}_{1}} , {v}_{{g}_{2}} , … )$$

$$where$$

$${\sum }_{i} {v}_{{g}_{i}} = {\sum }_{i} {b}_{{g}_{i}} = 1 {\hat{v}}_{who} = {\sum }_{{g}_{i} ∈ groups} ( {w}_{i} * ( {v}_{{g}_{i}} - {b}_{{g}_{i}} ) )$$

$$where$$

$${\sum }_{i} \vert {w}_{i} \vert = 1$$

An important part in this calculation is identifying the different groups that matter to a team (for example its email network). Given the groups, the benchmark values are simply the averages within each group. In this calculation framework, the computer system 10 can initialize the parameters with approximate values based on the structure of the company. With time, the accuracy of these parameters can be improved based on the collected data, and by cross-validation with other employees like the performance review system in the company. By using a statistical or machine learning approach like linear regression or support vector machines the computer system 10 can identify the function, curve or surface best separating one group (say the highest performers) from another (say the lowest performers), as a function of the underlying variables measured by the computer system 10. This function, curve, or surface serves as an indicator of effectiveness 1 when applied to the measurements associated with a particular individual.

Work activity 65 measures the length of an average workday based on the times when an employee was actively engaged. This includes, for example, the times when people read, write, forward, move or delete messages. This score lies in the range [0, 24]. A representative calculation might be the number of distinct hours during which the employee writes at least one email per hour. Other measurements can similarly be defined from the underlying data extracted from the communications data 60. An alternate measure might give particular credit for communications conducted outside of the usual workday, as indicative of greater engagement and commitment.

In another embodiment, the computer system 10 determines a communication vibrancy score, which is a measure of the cost of communications with a particular customer. The communication vibrancy score captures the higher cost associated with immediately responding to communications (as opposed to simply reading emails and responding to the emails after a week or more). To determine the communication vibrancy score, the computer system 10 combines a measure of employee response time to emails (or other communications) from the customer with the communications volume 64 for that customer. The communication vibrancy score may be also combined with content length, sentiment 55, engagement, etc. Immediate responses typically require employees to drop what they are currently working on to write the response, thereby incurring a higher cost to the company. Conversely, responding to emails after a week or more likely means that the employee responded when he/she had time to spare, thereby incurring a lower cost to the company.

In another embodiment, the computer system 10 may identify and delete communications data 60 and/or interaction data 70 containing sensitive information. In one variant, the computer system 10 determines for each of the plurality of communications data 60, a subject/topic and deletes communications data 60 having its subject/topic associated with a sensitive subject/topic. Legal requirements and cultural mores render certain topics discussed in email and other communications too sensitive to disclose to others. An example would be disclosing pregnancy status before an employee would choose to reveal this news. Further, private and sensitive information related to the personal life of employees may be concealed, such as: identifying information like email address, name, nickname, phone-number, position, address, cubicle number etc.; security sensitive information such as credit card number, SSN, date of birth, etc.; and personal beliefs and background—e.g. religion, political beliefs, socio-economic background, and medical condition.

One approach is to detect patterns that can flag sensitive messages without even looking at content, such as emails from/to specific domains, emails from/to certain email addresses, and emails with certain subject/topic headings. Such patterns can also be employed to help filter out spam and automated messages along with sensitive messages. In this approach, messages pass through a series of filters before any data is collected. A message (communications data 60) whose sender 15 or recipient 16 is in a contact blacklist is discarded before the content is processed. The computer system 10 then scans the content of the message and extracts only fragments: selected topics and their associated sentiment 55 scores. Any topics in a Topic Blacklist can be immediately discarded. Each message need be stored in the system only for the few milliseconds between the download and extraction. The emails themselves can be discarded after content extraction.

A second approach concerns detections of sensitive topics by content. One class of sensitive topic patterns includes those that identify personal identification information like social security numbers, credit card numbers, and birth date. The second class concerns lists of blacklisted topics that should never be extracted. The most sensitive but restriction approach concerns the use of a white list of approved topics, where the NLP module never extracts numbers or topic strings unless they are white-listed.

In another approach, only information summarized over larger groups of people is disclosed. Privacy concerns in many organizations make it too sensitive to disclose communications patterns, topics, and sentiment 55 on an individual basis. In such situations it is important to disclose information only for groups of people. In addition, corporations are generally interested in the sentiment 55 and communications of departments, customers, management classes, and other types of personnel groupings.

In the recent past, statistical databases have become very common since they are very important for research and policy development. This requires person-specific data to support data mining, fraud detection, and homeland security stimulating much interest in the technical safeguards for data. The book by Denning [20] presents four kinds of safeguards: (1) Data encryption attempts to prevent unauthorized disclosure of confidential information in transit or storage; (2) Access controls regulate which users may enter the system and subsequently which data sets an active user may read or write.; (3) Flow controls regulate the dissemination of values among the data sets accessible to a user; and (4) Inference controls protect data by preventing questioners from deducing confidential information by posing carefully designed sequences of statistical queries and correlating the responses.

One embodiment of the present invention uses standard encryption and access control technologies to control who has access to information. Flow and inference controls are the approaches used to secure sensitive data by controlling the views presented to end users. In another embodiment, K-anonymity has been used for publishing microdata, such as census, medical and voting registration data. A dataset is said to be K-anonymized, if each record is indistinguishable from at least K−1 other records with respect to certain identifying attributes. This technique prevents inference attacks by generalizing and/or suppressing portions of the released data so that no individual can be uniquely distinguished from a group of size k.

Finally, aggregation—publishing totals from representative demographic groups instead of data from individuals—is another important privacy preserving technique. Confidentiality is preserved when the groups are large enough to conceal particularly distinguishing characteristics or beliefs in the aggregate, but breaks down in the face of small groups (say, single person departments or underrepresented ethnic groups), or more insidiously when presenting multiple totals from combinatorially-connected groups. There is a rigorous theory of preserving privacy in aggregate totals from interconnected groups (see Gusfield, D. A graph theoretic approach to statistical data security. SIAM Journal on Computing 17, (1988), 552, which is incorporated by reference herein) that serves as a foundation. Related work by Malvestuto et al. presents an approach to represent and audit aggregate queries which returns informative answers only if it does not reveal confidential data (see Malvestuto, F. M., Mezzini, M., and Moscarini, M. Auditing sum-queries to make a statistical database secure. ACM Transactions on Information and System Security (TISSEC) 9, 1 (2006), 31-60, which is incorporated by reference herein). This approach can be very powerful by allowing end users to slice data as they see fit, without accidentally revealing sensitive information.

Another embodiment of the present invention addresses the security of information technology that is of great and growing importance to the company. This embodiment pertains to security risks concerning the sending of unencrypted passwords through the mail, where they can be read or intercepted by unauthorized parties. In this embodiment, analysis of internal corporate communications can help ameliorate this risk. Certain topics extracted from the text can be readily identified as passwords, and the senders of such information identified and discourage from such behavior.

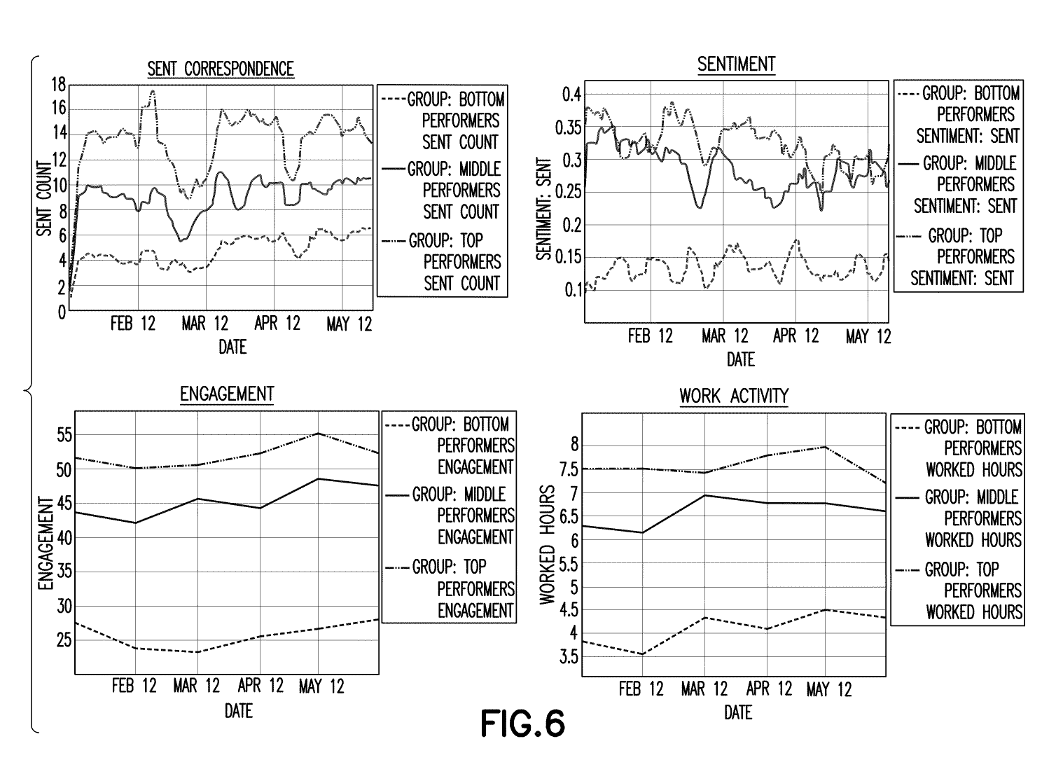

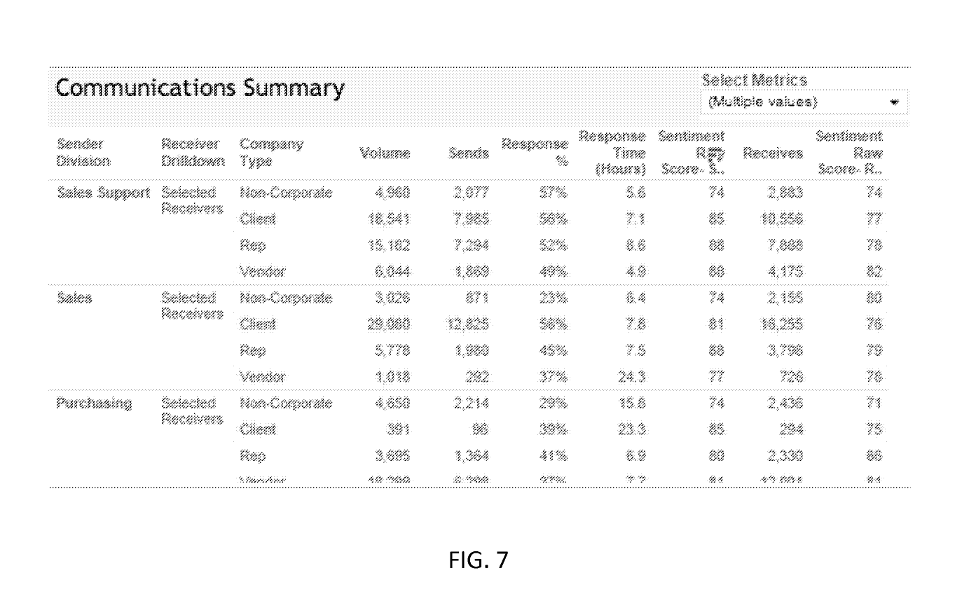

The effectiveness 1 may be provided to a user as a graphical chart, as numerical values to a table, or as any other visual display that allows the user to see or assimilate the effectiveness 1 of the entity over the time interval 3. Referring to FIG. 6, an exemplary screenshot displaying the send volume 54, sentiment 55, engagement 1 and work activity 65 for an entity 2 over a time interval 3 is shown. Referring to FIG. 7, a table with numerical values for communications volume 64, send volume 54, response percent (response index 56), response time (response index 56), sentiment 55, and receive volume 58 for a number of entities 3 (shown here as groups: Sales support, Sales, and Purchasing) is shown. The user may compare the effectiveness 1 of different entities 3 when looking at this table. An additional feature of this display is that a user can click on an entity 3, to see the effectiveness 1 for each entity segregated into subgroups (Non-corporate, Client, Rep, and Vendor). In this variant, a user can continue to click on the subgroups to “drilldown” to the metrics of smaller and smaller subgroups, until the displayed metrics are shown for a particular company within each subgroup or a particular employee's interaction with these subgroups. Likewise, a user can aggregate (“roll up”) the metrics of subgroups into larger groups. In another variant the user can segregate and aggregate the different metrics displayed in the table.

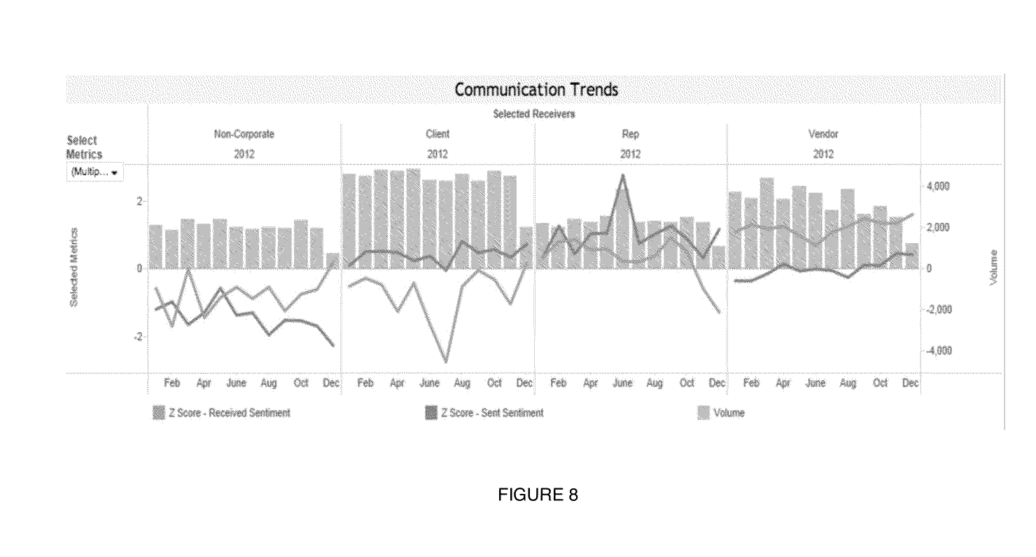

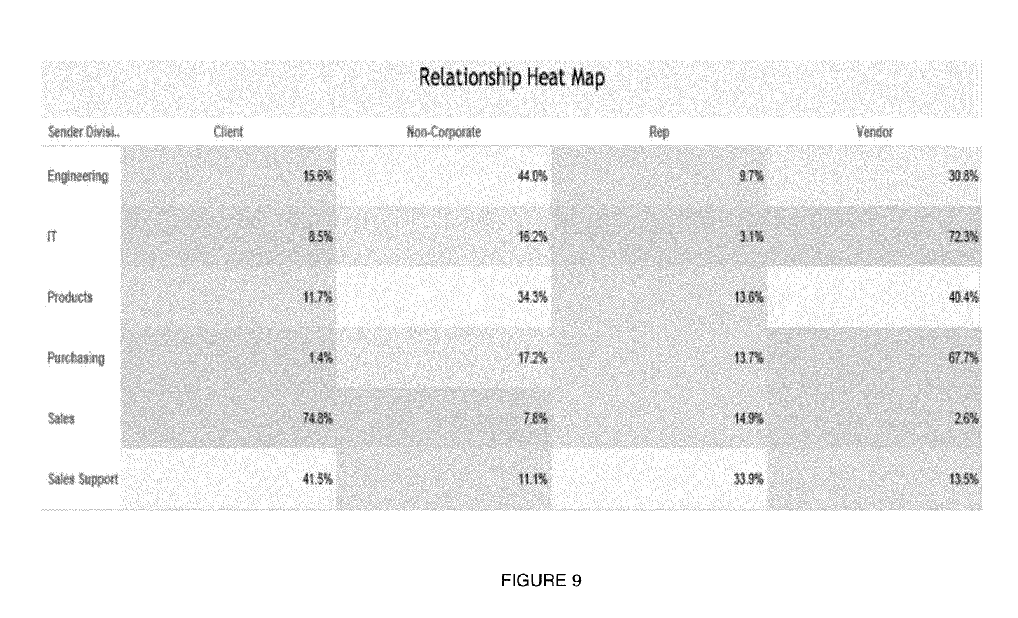

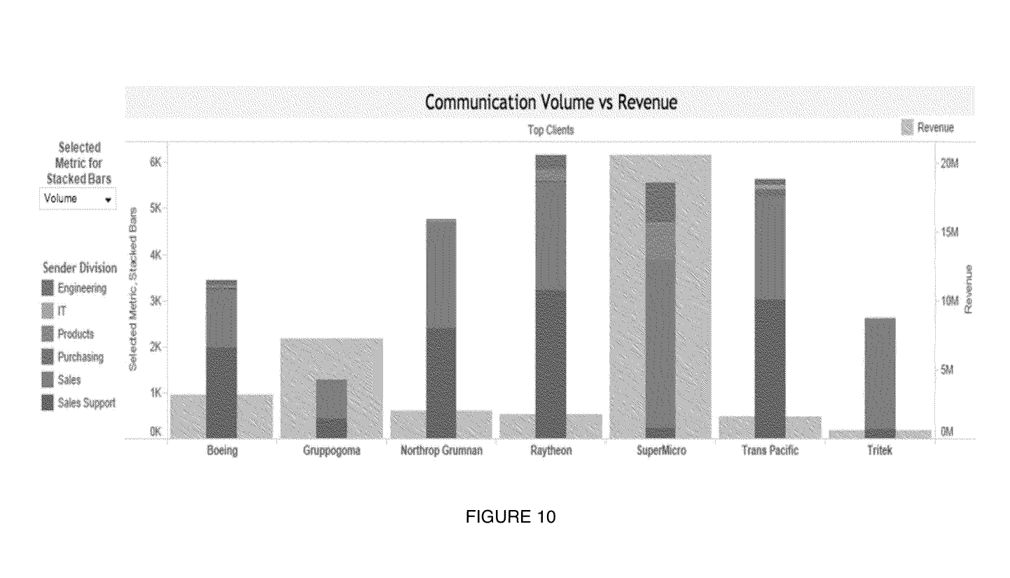

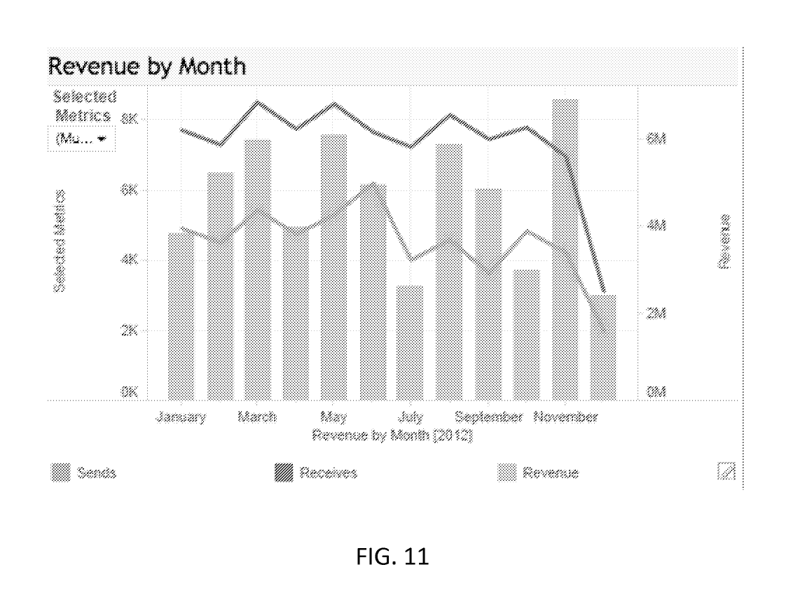

Referring to FIG. 8, the communications volume 64 and sentiment 55 are shown in graphical form for a number of entities 3 (Non-Corporate group, Client group, Rep group, and Vendor group). FIG. 9 shows a screenshot of contacts between entities 3 (alternatively, this can be displayed as a contact list 76). This chart allows the user to see the communications volume 64 between entities 3 as a percentage of all communications volumes 64 of the entities 3. FIG. 10 shows a bar chart representative of the communications volume 64 for groups of entities 3 (Engineering, IT, Products, Purchasing, Sales, and Sales Support) segregated into contacts (Boeing, Gruppogoma, Northrop Grumman, Raytheon, superMicro, Trans Pacific and Tritek) in the foreground with revenue received by the company from the contacts (an example of other data streams 66) in the background. FIG. 11 shows a bar chart representing the send volume 54 and receive volume 58 alongside the revenues received by the company. The communications volume 64 has been used only as an example in FIG. 8-FIG. 11. The user can select any and all metrics described above. Furthermore, the displays shown in FIG. 8-FIG. 11 are merely representative of the types of displays that may be used to represent the effectiveness 1, costs, relationships, and other similar metrics.

Managers of a company can monitor the effectiveness 1 to understand the work patterns of a specific work group—e.g. the top performers. Further, a manager can view the contact list 76 for a team or customer to understand who employees talk to the most, which relationships are dropping off, who employees respond to the quickest, who employees have the most positive interactions with and so on. This can help the manager understand important questions like: where in the organization are the points of contact with key accounts? Which customers are consuming the most support and sales resources? Which departments are not communicating enough and causing gaps in critical coordination? Which accounts have the highest risk of cancelling a relationship? This data helps companies minimize surprises and take action in time to salvage key accounts and prevent further erosion in workforce engagement.

In another embodiment, the computer system 10 receives from the user a different entity 2 or a different time interval 3. In this embodiment, the computer system 10 identifies which of the plurality of the communications data 60 has its participant 17 associated with the different entity 2 and its time stamp 68 within the initial time interval 3 (or its participant 17 associated with the same entity 2 and its time stamp 68 within the different time interval 3) and determines a second effectiveness 1 using the secondly identified communications data 60. The computer system 10 then determines a comparison measure (or productivity measure) based on the difference between the initial effectiveness and the second effectiveness and then displays to the user the comparison measure (or productivity measure). The productivity measure may be a health indication of the entity, an indication of an adoption of an initiative, an indication for an environment adjustment, or an indication of a performance projection.

In one variant of this embodiment the signals of responsiveness 56 and effectiveness 1 can be directly connected as inputs to the HVAC and other work environmental systems. Whenever a particular individual or co-located groups exhibits decreasing alertness, environmental monitoring systems can provide more stimulating conditions, for example, by changing the thermostat or the tempo of the ambient music.

In another variant, whenever there is a merger and applications situation, a critical issue concerns the level of buy-in from both sides of the deal. Are the cultures of the two companies aligned? Have proper communications patterns been established between units of the two organizations? Does the sentiment 55 in references to the other organization reflect a growing partnership, or us-versus-them? Valuable intelligence as to the health of the deal can be obtained using the present invention.

In another variant, negotiations can be analyzed for the require levels of engagement and sentiment 55 between the negotiating partners. Analysis of communications streams will help reveal the current mental state of the other parties, providing intelligence which will help decide whether one should raise or lower ones bid. For example, it is important to understand the mental state of the party one is negotiating with to identify the best strategy. Are they getting upset, tired, or frustrated? Slowing response times indicate possible disengagement in the negotiations. Decreasing sentiment 55 may indicate frustration. Proper negotiation strategy requires recognizing these conditions and responding to them.

In one variant, analyzing the responsiveness (response index 56), sentiment (55), and/or effectiveness of people provides important clues as to an individual's physical and mental health. Regular patterns of sentiment 55 can provide signals of depression, or converse whether an employee had a good and restful weekend. Changes in the typing speed, accuracy, and grammatical complexity may be signals for degenerative mental conditions like Alzheimer's disease. For example, the computer system 10 can perform an analysis of typing speed over time and compare the trajectory to that of other, previously observed personnel. By performing a nearest-neighbor calculation, the computer system 10 can identify whether the most similar trajectories belong to healthy or impaired individuals.

The software (and data) enabling the method of the present invention can reside either behind a corporate firewall (as shown in FIG. 1) or in a distributed cloud-computing environment. It should also be understood that the method of the present invention may be executed on any computer system, client terminal and/or network-connected device. It should be appreciated that the term “communications data” 60 as used herein, in its broadest sense, can comprise any data that a user may wish to access, retrieve, review, etc.

Although the preferred embodiments of the invention have been described above by way of example only, it will be understood by those skilled in the art that modifications may be made to the disclosed embodiments without departing from the scope of the invention. For example, the present invention may be used in education environments to prevent bullying and more severe crimes. Society has grown increasingly sensitive to issues of social cliques and the impact of cyber-bullying. Educational institutions from grade schools to high schools, as well as colleges and universities provide a rich array of email and social networks to facilitate communications between students and educators. Analysis of these communications streams using the present invention will identify social cliques (through regular patterns of communication between a group of individuals) and cyber-bullying (through an analysis of the sentiment in the communications of two or more students).

Furthermore, various embodiments described herein or portions thereof can be combined without departing from the present invention. For example, the computer system 10 may consist of multiple computers or may be a special purpose device (such as including one or more application specific integrated circuits or an appropriate network of conventional component circuits) or it may be software configured on a conventional personal computer or computer workstation with sufficient memory, processing and communication capabilities to operate as a terminal and/or server, as will be appreciated to those skilled in the relevant arts. The computer system 10 may communicate with client terminals through direct connections and/or through a data network to which some components are not connected. As another example, the devices need not be provided by a server that services terminals, but rather may communicate with the devices on a peer basis, or in another fashion. The computer system 10 is not limited to a computer or server, but can be manifested in any of various devices that can be configured to communicate over a data network and/or the Internet 4. The system may be any network-connected device including but not limited to a personal, notebook or workstation computer, a terminal, a kiosk, a PDA (personal digital assistant), a tablet computing device, a smartphone, a scanner, a printer, a facsimile machine, a multi-function device (MFD), a server, a mobile phone or handset, another information terminal, etc. Each device may be configured with software allowing the device to communicate through networks with other devices.

The above-described embodiments of the present invention are presented for purposes of illustration and not of limitation, and the present invention is limited only by the claims that follow.

We claim:

1. A computer implemented method for providing an effectiveness of an entity, comprising:
a computer receiving a plurality of communications data from a network;
the computer determining for each of the plurality of communications data, a participant, a time stamp and interaction data;
the computer receiving from a user a selected entity and an initial time interval;
the computer firstly identifying which of the plurality of the communications data has its participant associated with the selected entity and its time stamp within the initial time interval;
the computer determining a communication volume associated with a quantity of the firstly identified communications data;
the computer determining a sentiment, the sentiment determined from the interaction data of the firstly identified communications data;
the computer determining a response index, the response index determined from the interaction data of the firstly identified communications data;
the computer providing an initial effectiveness by aggregating the communication volume, sentiment, and response index; and
the computer displaying to the user the initial effectiveness.

2. The method of claim 1, wherein the response index is based on time differences between the time stamps of the firstly identified communications data and corresponding interaction times contained in the interaction data of the firstly identified communications data.

3. The method of claim 1, further comprising:
the computer receiving from the user, a minimum effectiveness level; and
the computer generating an alert to the user when the initial effectiveness falls below the minimum effectiveness level.

4. The method of claim 1, wherein the selected entity represents more than one participant.

5. The method of claim 4, wherein each of the participants is associated with the selected entity by an input.

6. The method of claim 1, wherein the communications data comprises electronic communications data.

7. The method of claim 1, wherein the communications data comprises physical interaction data.

8. The method of claim 1, wherein the sentiment is determined for at least one identified topic.

9. The method of claim 1, further comprising:
the computer determining for the firstly identified communications data a content length associated with the interaction data, and
the computer aggregating the content length with the communications volume, sentiment, and response index to provide the initial effectiveness.

10. The method of claim 1, wherein the communications volume comprises a send volume and a receive volume.

11. The method of claim 10, wherein the response index is based on a difference between the send volume and the receive volume.

12. The method of claim 10, further comprising:
the computer identifying at least one association between the participants of the firstly identified communications data; and
the computer determining a location adjustment based on the at least one identified association.

13. The method of claim 1, further comprising the computer identifying and deleting sensitive interaction data.

14. The method of claim 1, further comprising:
the computer determining for each of the plurality of communications data, a subject; and
the computer deleting each of the plurality of communications data having its subject associated with a sensitive subject.

15. The method of claim 1, further comprising the computer displaying other data streams with the initial effectiveness.

16. The method of claim 1, further comprising:
the computer receiving from the user a different time interval;
the computer secondly identifying which of the plurality of the communications data has its participant associated with the selected entity and its time stamp within the different time interval;
the computer providing a second effectiveness using the secondly identified communications data;
the computer providing a productivity measure based on a difference between the initial effectiveness and the second effectiveness;
the computer displaying to the user the productivity measure.

17. The method of claim 16, wherein the productivity measure is a health indication of the selected entity.

18. The method of claim 16, wherein the productivity measure is an indication for an environment adjustment.

19. The method of claim 16, wherein the productivity measure is an indication of an adoption of an initiative.

20. The method of claim 16, wherein the productivity measure is an indication of a performance projection.

21. The method of claim 1, further comprising:
the computer receiving from the user input a different entity;
the computer secondly identifying which of the plurality of the communications data has its participant associated with the different entity and its time stamp within the initial time interval;
the computer providing a second effectiveness of the different entity using the secondly identified communications data;
the computer providing a comparison measure based on a difference between the initial effectiveness and the second effectiveness; and
the computer displaying to the user the comparison measure.

22. A computer system for providing an effectiveness of an entity, comprising:
an input for inputting a selected entity and an initial time interval;
a network connection for receiving a plurality of communications data;
a database for storing data;
a processing unit programmed to:
store the plurality of communications data in the database;
determine for each of the plurality of communications data, a participant, a time stamp and interaction data;
firstly identify which of the plurality of the communications data has its participant associated with the selected entity and its time stamp within the initial time interval;
determine a communications volume associated with a quantity of the firstly identified communications data;
determine a sentiment, the sentiment determined from the interaction data of the firstly identified communications data;
determine a response index, the response index determined from the interaction data of the firstly identified communications data; and
providing an initial effectiveness by aggregating the communications volume, sentiment, and response index; and
a display unit for displaying to a user the initial effectiveness.

23. The computer system of claim 22, wherein the response index is based on time differences between the time stamps of the firstly identified communications data and corresponding interaction times in the interaction data of the firstly identified communications data.

24. The computer system of claim 22, wherein the communications volume comprises a send volume and a receive volume.

25. The computer system of claim 24, wherein the response index is based on a difference between the send volume and the receive volume.

26. The computer system of claim 22, the processor unit further programmed to:
identify at least one association between the participants of the firstly identified communications data; and
determine a location adjustment based on the at least one identified association.

27. The computer system of claim 22, the processor unit further programmed to identify and delete sensitive interaction data.

28. The computer system of claim 22, the processor unit further programmed to:
determine for each of the plurality of communications, a subject; and
delete from the database each of the plurality of communications data having its subject associated with a sensitive subject.

29. The computer system of claim 22, the processor unit further programmed to:
receive from the input a different time interval;
secondly identify which of the plurality of the communications data has its participant associated with the selected entity and its time stamp within the different time interval;
providing a second effectiveness using the secondly identified communications data; and
providing a productivity measure based on a difference between the initial effectiveness and the second effectiveness; and
the display unit displaying to the user the comparison measure.

30. The computer system of claim 22, the processor unit further programmed to:
receive from the input a different entity;
secondly identify which of the plurality of the communications data has its participant associated with the different entity and its time stamp within the initial time interval;
providing a second effectiveness of the different entity using the secondly identified communications data; and
providing a comparison measure based on a difference between the initial effectiveness and the second effectiveness; and
the display unit displaying to the user the comparison measure.
